(19) United States
(12) Patent Application Publication
(10) Pub. No.: US 2023/0074740 A1
(43) Pub. Date: Mar. 9, 2023

(54) A DISTRIBUTED EVENT-DRIVEN ORDER MANAGEMENT SYSTEM AND A DATA MODEL FOR STRUCTURING DATA THEREIN

(71) Applicant: AMADEUS, Biot (FR)

(72) Inventors: Gerard YIN, Biot (FR); Francois Eric COGNE, Biot (FR); Aurelien Jean Christophe GRENOTTON, Biot (FR); David Laurent NOBLET, Biot (FR)

(21) Appl. No.: 17/799,196

(22) PCT Filed: Feb. 19, 2021
(86) PCT No.: PCT/EP2021/054195

§ 371 Date: Aug. 11, 2022

(30) Foreign Application Priority Data
Feb. 19, 2020 (FR) FR2001677

(51) Int. Cl. G06Q 10/02; G06Q 50/30

(52) U.S. Cl. CPC G06Q 10/02; G06Q 50/30

(57) ABSTRACT

The present invention relates to an order data model for structuring data records in an order management system. The order model is configured to decompose each order into its corresponding item data records and sub-item data records, which in turn are associated with fulfilment item data records containing information on the product and/or services to be fulfilled by an assigned provider. The order model may be configured to add, during the generation of data record, a number of placeholder data fields, which may be used by a range of systems and applications to add extra information on each data record.

### FIELD

The present invention relates to a data model operable for structuring data records storing product order information in an order management system. The present invention further relates to an order management system that uses the data model to monitor and manage the fulfilment of data records associated with a range of products or services irrespective of their type and providers.

### BACKGROUND

Order management systems are used by retailers to manage and process product orders placed by customers. In typical retail systems, orders have a short life cycle with limited changes. It is in the seller's interest to process the orders as soon as possible to increase customer satisfaction, preserve reputation and increase order-to-cash cycle efficiency. Changes in the products contained in the order are limited, and usually require the cancellation or regeneration of the existing order. Generally, once a product or a service is sold, it is considered to have reached the end of its lifecycle. For example, for a retailer selling concert tickets, when the tickets have been issued, the order lifecycle ends. Moreover, conventional systems are generally limited with respect to the expression of a user request. Conventional product order management systems do generally not allow to create orders consisting of various interlinked products or services, with their respective, possibly interlinked conditions. Conventional retailer systems do not have the capacity to process such orders either.

In the airline industry, the processing of orders is more challenging than for conventional retailers. The lifecycle of an order may be very long, and the order needs to remain active for the entire duration of the order. A passenger may purchase a flight up to two years in advance, and thus the order needs to remain active during those two years until the booked flight has been flown. Moreover, various factors influence the planning and implementation of a flight and potentially cause changes in schedules, routes, aircraft configuration, and the like. Therefore, during the lifespan of an order, an airline may not be able to deliver what was promised to the passenger when the order was placed. The airline industry is now adopting the New Distribution Capabilities (NDC) IATA standard, which allows airlines to create orders, that are customised to the user's need, possibly combining various, eventually, inter-depending products, allowing the user a high level of expressivity. In this context, it becomes essential to have an improved order management system that allows to define independently various components of an order, the relationship between these components and the conditions associated to each component, thus allowing to monitor each order component independently from one another to determine whether a purchased product or service was delivered according to the terms of service agreed upon placing of the order. In existing systems, once an order is placed it is very difficult to perform further changes, e.g. add another order item, or change one or more of the existing order items. In essence, in existing order management systems, once an order is placed it is considered as closed, with no or limited possibilities to the changes that can be made. As such, an improved order management system is required that would allow for independently processing of the different order items associated with an order. Conventional retailers will also benefit from this system as it allows a high degree of customisation and a tight and secure order follow-up.

### SUMMARY

An object of the present invention is to provide an improved order data model operable for structuring order data records storing information on product or service orders placed by a user that overcomes the limitations of existing solutions.

Another object of the present invention is to provide an improved distributed order management system that is capable of processing and managing changes to order items associated with an order. The order management system of the present invention is configured to maintain the order open until all items of the order have been fulfilled. As such, the user is able to change the order items, e.g. add, delete, amend, without triggering a compete regeneration of the entire order.

The above aims are achieved according to the systems and methods of the independent claims. Preferred embodiments are described in the dependent claims.

### BRIEF DESCRIPTION OF THE DRAWINGS

The following drawings are provided as an example to further explain and describe various aspects of the invention:

FIG. 1 shows an example of a commercial retailer platform according to embodiments of the present invention.

FIG. 2 shows an example of an Order Management System according to embodiments of the present invention.

FIG. 3 shows an example of an order data model according to embodiments of the present invention.

FIG. 4 shows an example of an order data record logical structure according to embodiments of the present invention.

FIG. 5 shows an example of a fulfilment data record logical structure according to embodiments of the present invention.

FIGS. 6 and 7 show an example of managing orders and monitoring their fulfilment according to embodiments of the present invention.

FIG. 8 shows an example of an event-driven streaming architecture for the commercial retail platform according to embodiments of the present invention.

FIG. 9 shows an exemplified implementation of the event-driven streaming architecture of the order management system according to embodiments of the present invention.

FIG. 10 shows a high-level implementation of the order management system according to embodiments of the present invention.

FIG. 11 shows an exemplified implementation of the data module of the event-driven streaming architecture according to embodiments of the present invention.

FIG. 12 shows an example of the data aggregation at the data module according to embodiments of the present invention.

### DETAILED DESCRIPTION

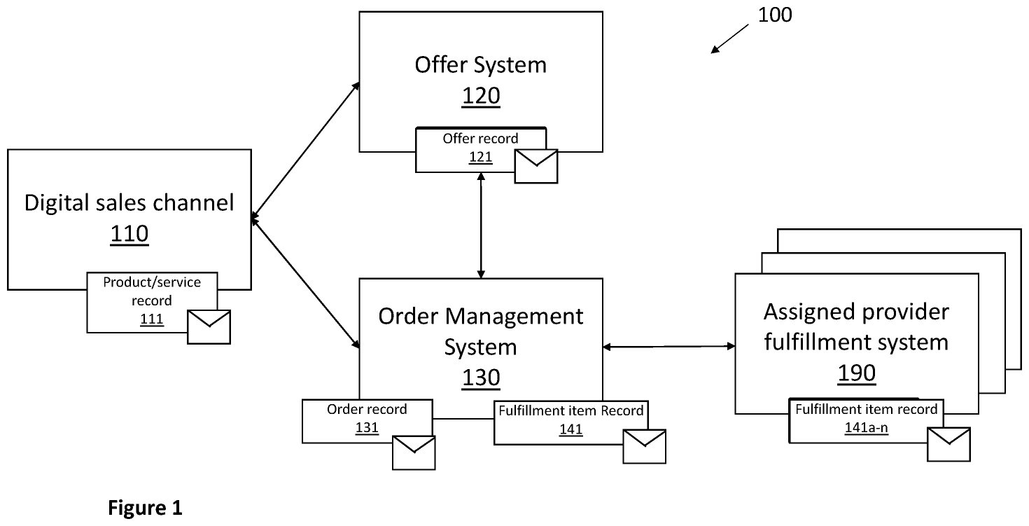

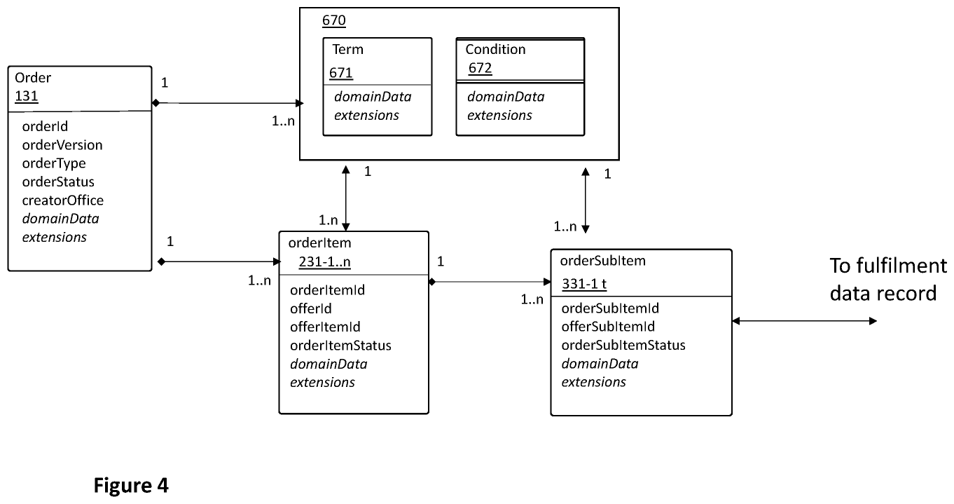

The present invention will be illustrated using the exemplified embodiments shown in the FIGS. 1 to 12, which will be described in more detail below. It should be noted that any references made to dimensions are only indicative and do not restrict the invention in any way. While this invention has been shown and described with reference to certain illustrated embodiments thereof, it will be understood by those skilled in the art that various changes in form and details may be made therein without departing from the scope of the invention. Furthermore, while the invention has been described with references to a particular data model for structuring order data records in an order management system and an order management system for managing and monitoring the fulfilment of order data records, it should be understood by those skilled in the art that changes in form and details may be made to facilitate other types of method and/or systems and/or data models in related fields without departing from the scope of the invention.

According to a first aspect of the present invention, a data model is provided. The data model is operable in a processor of an order management system for structuring data, the order management system is configured to manage product and/or service orders placed by users via a plurality of digital data channels, and manage and monitor their fulfilment by assigned providers according to corresponding contractual terms of service agreed between a user and a provider for the provision of the purchased products or services, the data model comprising:
a first data container configured to store a plurality of order data records storing information on product or service orders placed by the users through the digital channels and the corresponding contractual terms of service, each order data record being assigned an order identifier and comprising at least one order item data record storing information on the type of the purchased product or service and corresponding contractual terms of service, each order item data record comprising order sub-items specifying the product or services purchased by a user and the corresponding contractual terms of service, each order sub-item being assigned by the processor to a corresponding provider for fulfilment, wherein the terms of service specify actions to be taken when certain conditions are activated; and
a fulfilment data container configured to store a plurality of fulfilment item data records, each associated with a corresponding order sub-item data record of an order data record, each fulfilment item data record being configured to store fulfilment status information of a fulfilment item associated with a product or service referenced in the corresponding order sub-item data record.

According to embodiments of the present invention, each fulfilment item data record is configured to store changes and/or fulfilment errors associated with a fulfilment item.

According to embodiments of the present invention, the data model is configured, upon a registration of change and/or a fulfilment status error, to identify and retrieve from the corresponding order sub-item the contractual terms of service to determine the conditions to be checked following the change and/or fulfilment error and accordingly initiate the corresponding actions.

The data model of the present invention allows to monitor the fulfilment of each fulfilment item data record associated with an order sub-item data record. As such, the fulfilment of each individual sub-item associated to an item data record can be processed independently. In this way, changes to the order items can be made as long as at least one sub-item data record is still active. Therefore, with the data model of the present invention, it is possible to maintain a single order data record, while making changes to the comprised order items. Furthermore, with the data model of the present invention, each provider is presented only with the required information associated with the specified service to be fulfilled. In other words, the providers deal with independent segments of the order, without having knowledge of the remaining order items. In this way, unintentionally sharing information between providers is prevented. This is contrary to what currently exists, where the details of the whole order is available to the service providers. Therefore, the present invention reduces the need for sharing data between different providers, thereby enhancing data security. Moreover, the present invention allows for each independent fulfilment item to be transformed according to the needs of the system of the assigned provider. The present invention enables heterogeneous system to be connected to the order management system for the fulfilment of an order, e.g. legacy system. Furthermore, by independently processing the sub-items of an order item data record, it becomes possible to detect the fulfilment status of each sub-item, and detect, with finer granularity, changes occurring in specific parts of the order item data record. In this way, a set of corresponding corrective actions can be initiated to ensure that the conditions specified in the contractual terms of the order item are not triggered. As such, the data model of the present invention greatly reduces the processing load of the order management system, since only the affected sub-items of an order item data record would need to be checked, if a change or an error occurs. Furthermore, by independently processing the sub-items of an order item data record, it becomes possible to assign directly each order sub-item to the systems of different providers. This is contrary to what currently exists, where the entire data record is assigned to a main provider, whereby the different items are manually assigned to other providers for fulfilment of the different order items, thereby increasing complexity, reducing transparency, and increasing the processing requirements for the order management system. Furthermore, the present data model enables the linkage of each of the fulfilment item data records with a corresponding contractual term of service, specifying the terms and conditions agreed between the parties for the provision of the product or service at the purchase of the product or service. The information in the contractual terms of service provides a baseline for determining whether a purchased product or service has been fulfilled. The terms of service may specify actions to be triggered when contractual conditions are fulfilled or waived. The data model of the present invention enables the collection and storage of fulfilment information directly from the fulfilment system of the assigned provider of a purchased product or a service. As a result, fulfilment monitoring may be more accurately determined and a breach in the contractual terms of service due to a change or fulfilment error being registered for a corresponding purchased product or service may be resolved. As such, if a change is registered in the fulfilment status of a sub-item, the contractual terms of service are checked to determine whether the conditions assigned to the fulfilment of the product have been fulfilled. If the conditions have not been fulfilled, then the data model is configured to retrieve a set of corresponding actions to be processed by the order management system to ensure compliance with the contractual terms of service. The actions may be triggered in the form of workflows, defining the steps to be followed to ensure compliance. The steps may be performed automatically, thereby the user and the provider may only receive notifications associated with the actions initiated and the resulting measures that have been taken. In this way, the process of resolving disputes between parties is simplified.

According to embodiments of the present invention, each data record in the first data container and fulfilment data container comprise placeholder data fields configured to store extension data for enriching the description of the corresponding data records.

According to embodiments of the present invention, the contractual terms of service in each corresponding data record are in the form of an extensible mark-up language. For example, every term and/or condition may be represented by a key and a value. According to embodiments of the present invention, the key identifies the type of the corresponding term or condition, while the value comprises data that is specific to the given term or condition type. For example, the value may be in any suitable form and may represent a range of data, e.g. a time limit condition may contain a time limit as a value.

According to embodiments of the present invention, the fulfilment data container is configured to obtain fulfilment information of an order sub-item from a fulfilment monitoring system communicatively coupled to the fulfilment system of the assigned provider.

The data model of the present invention enables each data record to be extended with additional information during the period in which it remains active in the order management system. As a result, the description of the products or services may be enriched at any point during the lifecycle of an order. This is achieved by adding placeholder data fields to each of the data records generated by the data model of the present invention, e.g. the order data record, the order item data record, the order sub-item data record, and the fulfilment item data record, or any other desirable data record generated, processed or managed by the present data model. Therefore, the present data model may be considered as an extensible data model, which enables specific data to be added seamlessly to each one of the data records generated and/or managed by the OMS. The Order Management System enables all processes interacting with each one of the data records to manipulate the added data. In general, any external and/or internal process to the OMS may implement its own logic to decode the added data and trigger a logic within the OMS and/or an action. Therefore, the present data model may enable:
application components configured to interact with the order management system to add their own domain data enriching the order description without the need to request development or integration of the content on the order side, which is in contrast with existing commercial retailer platforms. For example, the proposed order data model may natively propose placeholders to the application components to add the required data. As a result, it is enabling a retailer, e.g. an airline, to sell a range of product types without the need to develop a single line of code to support the new content. An example of an application component may be a hotel backend system, which may be enabled to interact with the order data records and corresponding fulfilment item data records to add additional data on hotel rooms.
Third-party developers to add extensions, i.e. bespoke data enriching the order description without having to request development or integration on order side, as the order data model natively proposes placeholders for them to add this data. For example, the bespoke data may be configured to be decoded only by the provider of a fulfilment item. In this way, certain information may be protected. In another example, a provider may add specific metadata to a particular order data record, which enables the order data record to be identified in another process e.g. reconciliation of the order with other records.
The offer management or any component interacting with the offer management system may add any type of known or unknown terms and conditions to the offer. The T&Cs are described in an open and extensible description language, and software to decode this language can be executed at various stages of order management to enforce the terms and conditions.

According to embodiments of the present invention, the data model comprises an association data container storing a relationship mapping between the order sub-item data records and fulfilment data records. The data model may further comprise a provider data container specifying a relationship mapping between each fulfilment data record and a fulfilment system of a provider. The order data model maintains an association between the different data records, and with the assigned providers to ensure the correct processing of each order.

According to embodiments of the present invention, each order sub-item data record may be assigned to a user. For example, an order may be a group order, which may contain a range of product items, which may be specific to the whole group, e.g. ticket class, or to the individual, e.g. a specified seat preference.

According to a second aspect of the present invention, an order management system (OMS) is provided. The order management system is configured to manage product or service orders placed by users via a plurality of digital data channels and monitor their fulfilment by the assigned providers according to corresponding contractual terms of service agreed between a user and a provider for the provision of the purchased products or services, the terms of service specifying actions to be taken when certain conditions are met, the order management system comprising:
a communication module configured to receive order input data from the plurality of digital channels and monitoring data from at least a central data integration hub, wherein each order input data comprises order data associated with a product and/or service order placed by a user at a digital channel, and wherein the monitoring data comprises data associated with the fulfilment of an order;
a database management system configured to store data associated with the received product or service orders;
a processing module configured to process each order input data to extract order data comprising information on the order items, order sub-items, and corresponding contractual terms of service contained, and generate, based on the order data model of the first aspect of the present invention, the corresponding order data record, one or more order item data records associated with each order item in the order, one or more order sub-item data records associated with sub-item specified in the order items of the order, and one or more fulfilment item data records associated with the one or more sub-items data records;
wherein the processor is configured to associate and transmit, based on a first data portion of the order data, each fulfilment item data record to a fulfilment system of a corresponding provider; and
wherein the processor is configured to monitor the fulfilment status of each fulfilment item data record by the assigned provider based on the monitoring data received at the communication module.

According to embodiments of the present invention, the processing module the processor is configured, prior to the transmission of a fulfilment data record, to check the compatibility of the data format of the fulfilment data record with the data format of the fulfilment system of the assigned provider, and wherein upon detecting an incompatibility, the processor is configured for converting the data format of the fulfilment data to a data format that is compatible with the fulfilment system of the assigned provider.

According to embodiments of the present invention, the processing module is configured, upon registering a change and/or an error in the status of the fulfilment item data record, to identify and retrieve from the corresponding order sub-item data record the contractual terms of service to determine the conditions that need to be checked following the change and/or fulfilment error and initiate, based on the retrieved terms of service, a set of corresponding actions associated with the fulfilment status information.

According to embodiments of the present invention, the processing module is configured to sequentially iterate through the set of corresponding corrective actions, until a corrective action is identified that satisfies the contractual terms associated with the affected order sub-item. For example, the corresponding actions may be in the form of a workflow, where after taking an action the processing module is configured to check whether the corrective action resolves the contractual term violation, and if not continue to the next action.

According to embodiments of the present invention, the communication module comprises a data ingestion module configured to process the monitoring data received from the central integration hub to determine whether the data format of the monitor data is compatible with the processing format of the order management module, and wherein upon detecting an incompatibility, the data ingestion module is configured to transform format of the monitoring data. The central integration hub may be configured to collect data from different peripheral systems that are associated with desired service. For example, in the airline industry, the central integration hub may collect data from a variety of systems associated with a travel product such as departure control system, air/ground traffic information system, airport systems, weather systems, and the like. As such, the order data management system is provided with a range of information that can be used to assess the state of fulfilment of an order sub-item. For example, in the case of a connecting flight, a departure delay may be flagged by the air traffic system, which may be interpreted that the traveller will not be able to make the connecting flight. As such, the order management system may initiate a number of corrective actions to resolve the issues arising from the departure delay.

According to embodiments of the present invention, the first data portion comprises information identifying the fulfilment system of the provider assigned to fulfil the fulfilment item. According to embodiments of the present invention, the order management system is communicatively coupled to a travel offer management system.

According to embodiments of the present invention, the input data stream comprises provider identification information and product or service identification information, wherein the processor is configured to route the fulfilment data records, based on the provider identification information of the corresponding input data streams.

According to embodiments of the present invention, the communication module comprises a data ingestion module configured to process the monitoring data received from the central integration hub to determine whether the data format of the monitor data is compatible with the processing format of the order management module, and wherein upon detecting an incompatibility, the data ingestion module is configured to transform the format of the monitoring data.

According to embodiments of the present invention, the data ingestion module is configured to process the input data streams in real-time to extract events associated with product or service orders.

According to embodiments of the present invention, the processing module is configured to aggregate information associated with each order data record received from a plurality of communicatively coupled processing systems.

According to a third aspect of the present invention, a computer implemented method for processing and structuring data in an order management system is provided. The method comprises the steps:
receiving input data from a touchpoint, the input data associated with a data object comprising one or more data item objects, and each data item object comprising one or more data sub-item objects;
processing the data object and generate for each data item and associated data sub-item objects a corresponding data record, which is stored in a database of a database management system, each data sub-item object comprises a set of fulfilment conditions that need to be satisfied for the provision of a service by a service provider;
generating for each data sub-item a corresponding data fulfilment object;
   communicating the data fulfilment object to the fulfilment system of the assigned service provider; and
monitoring the fulfilment status of the data fulfilment object by the assigned application provider;
   wherein the step of monitoring the fulfilment status comprises the steps of:
receiving monitoring data from a central data integration hub associated with the fulfilment status of the data fulfilment object;
determining based on monitoring data and/or input data received from the touchpoints a change and/or an error in the fulfilment status;
and wherein, upon detecting a change and/or error, retrieving the corresponding fulfilment condition to determine whether the detected change and/or error triggered any of the fulfilment conditions; and
if the change and/or error caused certain conditions to be triggered, initiating a set of corresponding corrective actions to satisfy the triggered conditions.

The method of the present invention is configured to process input data containing a data object associated with an order for product and/or services placed by a user at a digital touchpoint. Each data object comprising one or more data items associated with the order items of the order. Each data item may further comprise one or more data sub-items associated with corresponding order sub-items linked to the order items of the order. The order is processed and for each data sub-item a data fulfilment object is created which is communicated to an assigned provider. The status of the fulfilment is monitored to detect changes and/or errors that may violate the contractual conditions applied to the data object. Similarly, changes to an existing order may be received, which need to be checked for violation of the contractual conditions. In the case of a change and/or error the applicable contractual terms are retrieved and if any conditions are violated a set of corrective actions are initiated.

According to a fourth aspect of the present invention, a computer program product is provided comprising instructions, which when executed by a processing module of an order management system are configured to process and structure data according to the steps of the method of third aspect of the present invention, wherein the processing and structuring of the data is based on an order data model according to the first aspect of the present invention.

The order management system (OMS) of the present invention takes advantage of the data model described previously to manage and monitor the fulfilment of individual products or services referenced in an order placed by a user, for example, in an offer management system. As such, each independent order item may be actioned for fulfilment to a corresponding system of a provider, rather than actioning the entire data record as it is the case with existing solutions. The order management system of the present invention enables for the individual monitoring of order items, thereby in the case of a change and/or an error occurring in an order item, certain actions may be triggered that correspond to the status of the affected item, while the remaining order items remain unaffected. This is contrary to existing solutions, where a change in a single order item would trigger the re-generation and re-processing of the entire data record by all systems, thereby affecting the processing load present at the order management and peripheral systems. The proposed OMS is configured to communicate directly with the fulfilment system of the assigned provider to collect fulfilment status information on each fulfilment item. Based on the fulfilment status information and details on requests for changes made to the purchased product or service, the OMS may trigger actions specified in the corresponding terms of service conditions. The proposed OMS, contrary to conventional systems, may use only a portion of the data contained in the product or service order. For example, the OMS may use a first data portion of the order identifying the details of the assigned provider fulfilment system. As a result, the proposed OMS does not necessarily need to have full knowledge of the description of the product or service purchased. Therefore, the proposed OMS offers a flexible configuration that may support handling different types of services and products without the need for additional development or integration. As such, a retailer may easily add new products and services without the need for requesting development or integration on the order side. Furthermore, since the proposed OMS requires only specific information of the order to be made visible, it may allow for the remaining information, specifically security-sensitive information, to be protected. For example, the OMS may be configured to forward a product for fulfilment to an assigned provider based on the identification of the provider without knowledge of the content of the order, which would become visible only to the provider. As such, sensitive information, e.g. passenger names, price, and the like, may be protected.

FIG. 1 shows an example of an airline commercial retailer platform 100 according to embodiments of the present invention. The commercial retailer platform may be provided with an order management system (OMS) 130 that is configured to manage product and/or service orders placed by users and monitor their fulfilment by the assigned provider(s) according to corresponding contractual terms of service agreed between a user and a provider for the provision of the purchased products or services. The OMS 130 may be communicatively coupled via a communication link to an offer management system 120 and/or a digital channel 110, to receive information on the orders placed by users. The order information may be in the form of offer data records 121, which are generated by the offer management system, and/or product/service data records 111, which are generated from the digital channel 110, e.g. a digital sales channel. The offer management system 120 may be configured to generate product and/or service offers in response to queries received from a user through an interface of a digital channel 110, e.g. a digital sales channel. Once an offer is selected and payment instructions are received from the user, the offer management system 120 is configured to generate an offer record 121 containing details about the product and/or service items purchased, and the corresponding contractual terms of service agreed between the user and the provider at the time of purchase. The terms of service may comprise a set of terms and conditions.

Conditions are safeguards that limit the capability to change the order from one state to another. Conditions can either be not fulfilled, fulfilled or waived. When processing an order state change, the OMS must check that all conditions are either fulfilled or waived. A term is a clause that parties agree upon and must abide to as part of the contract. A term can be “respected” or “violated”. For example, a traveller Mr. G may book a flight that is partially refundable if he is unable to take the flight because of an illness. When booking the flight, Mr. G agrees that, in case of an illness, he should provide a medical certificate in order to get a partial refund. The corresponding order may have associated conditions “Refund condition: flight not flown” and “Refund condition: provide medical certificate”. The order may have associated terms “Term: Refundable” and “Term: Refund penalty: 50 euro”. If the order is cancelled, the OMS will check the conditions to determine whether it can pass from the state “cancelled” to the state “refunded”. If Mr. G proves that he has not flown and provides a medical certificate proving he is unable to travel, a partial refund will be made according to the terms agreed upon.

The OMS 130 generates, in response to receiving an offer record 121 or a product/service record 111 from the digital channel 110, an order data record 131 configured to store information on product and/or service orders placed by users, and the corresponding contractual terms of service. The OMS 130 is configured to generate, based on the order data record 131, a corresponding fulfilment data record 141, which is configured to store information on the product and/or service items to be fulfilled. Each fulfilment item is forwarded to the assigned provider fulfilment system 190 for fulfilment. The OMS 130 is configured to monitor the fulfilment status of each fulfilment item and accordingly validate the fulfilment status information against the corresponding terms of service to determine if the specified conditions have been met. Depending on the determination, the OMS 130 may trigger certain actions and or notify extension services e.g. external applications, to take the necessary actions. As such, the present invention enables the processing of each order item contained in an order data record independently from one another. Therefore, in the case of a change and/or error only the affected order item needs to be processed, rather than the entire data record as it is the case with existing solutions.

Taking again the above example, if the OMS finds that the fulfilment status of the flight in the order of Mr. G is “unfulfilled”, the OMS will check whether Mr. G has flown and, if this is not the case, whether a medical certificate has been provided. If Mr. G has not flown and a medical certificate has not been provided, the OMS may send a message to Mr. G reminding him to send a medical certificate in order to be entitled to the partial refund.

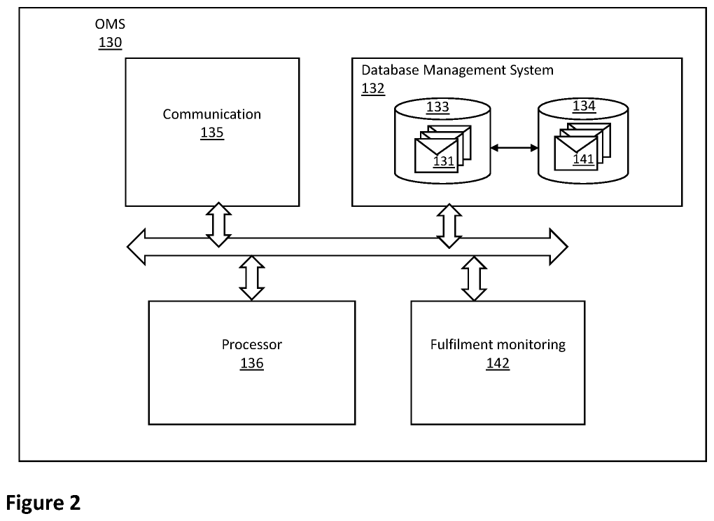

FIG. 2 shows an example of the order management system architecture. As shown the OMS 130 may comprise a communication module for establishing communication for the exchange of information with external systems such as the offer management system 120, a digital sales channel, a payment system, an assigned provider fulfilment system 190, and the like. The OMS may be provided with a database management system 132 comprising a first data container 133 for storing order data records 131, and a fulfilment data container 134 for storing fulfilment data records 141. It should be noted that the order and fulfilment data records 134 and 141 may be equally stored in the same database. A processor 136 is provided to process offer records received from the offer management system 120 and/or product/service orders received from one of the digital sale channels 110 to extract information on the order items, order sub-items, and corresponding contractual terms of services contained therein. Based on the extracted data, the processor is configured to generate an order data record 131 storing information on the product and/or service order and the corresponding contractual terms of service. Each order data record 131 is assigned an order identifier and comprises at least one order item data record 231 also referred to as contract item data record, storing information on the type of the purchased product or service and corresponding contractual terms of service. Each order item data record 231 comprises order sub-items 331, specifying the products or services purchased by a user and the corresponding contractual terms of service, each order sub-item 331 being assigned to a provider for fulfilment. The processor 136 is configured based on the extracted data on order sub-item 331 to generate at least one fulfilment item data record 241 storing fulfilment status information of a fulfilment item associated with a product or service referenced in the corresponding order sub-item data records 331. The fulfilment item data records 241 may be part of a fulfilment data record 141 associated with a corresponding order data record 131. Each fulfilment item data record 241 is associated with the fulfilment system of the assigned provider. For example, the processor may be configured to associate each fulfilment item data record 241 with a provider based on a set of information contained in the order data record 131, e.g. the name of the provider system. The order data record 131 and fulfilment data record 141 are respectively stored in the first data container 133 and fulfilment data container 134 of the database management system (DBMS) 132. The processor is configured to transmit each fulfilment item data record 241 to the assigned provider fulfilment system 190, and accordingly monitor, by means of a fulfilment monitoring module 142, the fulfilment status of each fulfilment item data record. For example, the monitoring module 142 may periodically query the fulfilment system 190 of a provider to obtain information on the fulfilment status of each fulfilment item. The processor 136 may store the fulfilment status information and changes associated with a fulfilment item to the corresponding fulfilment item data record. The processor 136 is configured, upon registering a change and/or a fulfilment status error on a fulfilment item to identify and retrieve from the corresponding order sub-item the contractual terms of service to determine the conditions that need to be checked following the change and/or fulfilment error and accordingly initiate the corresponding actions.

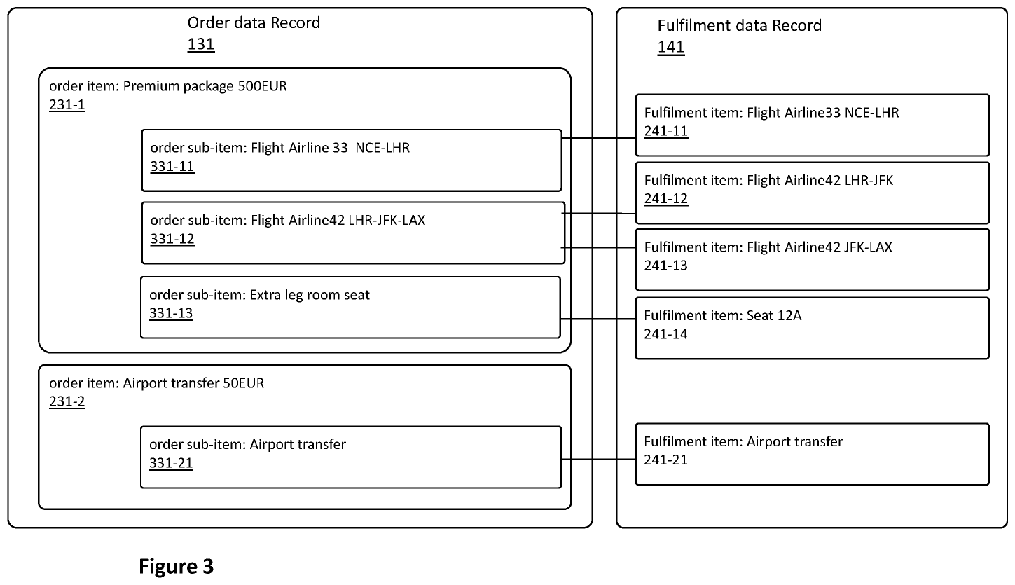

FIG. 3 shows an example of a data model for structuring data in a database management system (DBMS) 132 of an OMS 130 according to embodiments of the present invention. The DBMS 132 may comprise at least one database for storing data records. As shown, each data record 131 generated by the system comprises at least one order item data record 231-1 to n. For example, as shown in FIG. 3, the order item data record indicates that the purchased service is a “Premium package” worth 500 EUR. Each order item data record may comprise at least one order sub-item data record 331, indicating the product that the user has purchased. For example, order sub-item 331-11 specifies details of a flight with Airline 33 such as the flight number, the origin and destination and the schedule, while order sub-item 331-13 specifies that the passenger has also purchased a seat with extra legroom. Several order items can be added to a single order data record 131. Each order item and order sub-item provides details on the products and/or services that have been purchased by the passenger, which creates a baseline for assessing whether a purchased product and/or service has been fulfilled. Each order sub-item 331 is associated with at least one fulfilment item 241, indicating the assigned provider and the details of the product. In the example of FIG. 3, order sub-item 331-11 is associated with one fulfilment item 241-11, since the flight from NCE-LHR is considered as one item that needs to be fulfilled. On the other hand, order sub-item 331-12 is a multi-leg flight; thus it is linked to two fulfilment items 241-12 and 241-13, each specifying the details of the associated leg of the trip and the assigned provider, which in this case is “Airline42”. In the case where there is an issue with the fulfilment of one of the fulfilment items, for example a disruption preventing the second leg to be fulfilled, this will trigger the conditions specified in the terms of service associated with the corresponding order sub-item 331. As a result, decomposing the order items into its essential order sub-items 331 and decomposing these in one or more fulfilment items 241, enable the fulfilment of each order sub-item 331, and hence the fulfilment of the corresponding order item 231 and encompassing order 131 to be monitored with the finest granularity, which is not possible with existing solutions. Furthermore, with the proposed order data model, more flexible rules for defining a service and/or a product may be implemented. For example, rather than specifying a seat number, it becomes possible with the present order data model to define a parameter of the seat, e.g. extra legroom, or window seat. In this way, in case of changes, it becomes easier to identify whether a change in an individual order item would cause a breach of the terms and conditions specified for the purchased product, and accordingly take the necessary actions associated with the order sub-item, while the remaining sub-items remain unaffected by the detected change and/or error.

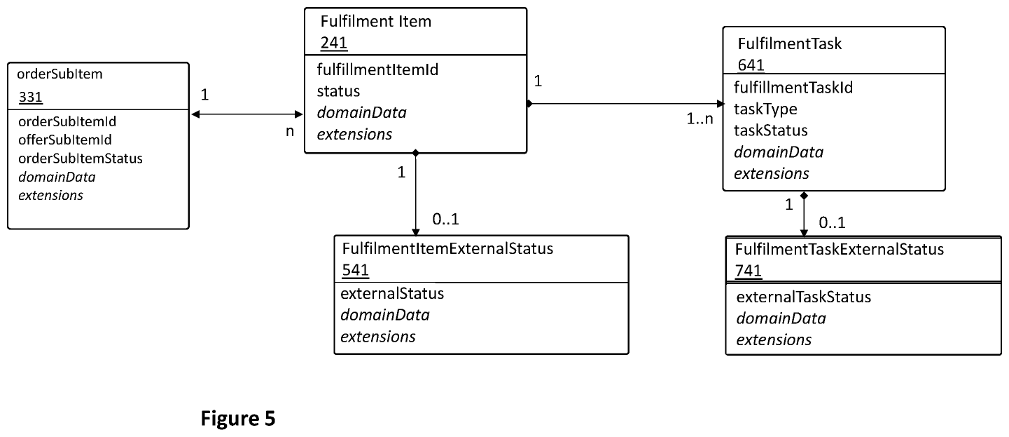

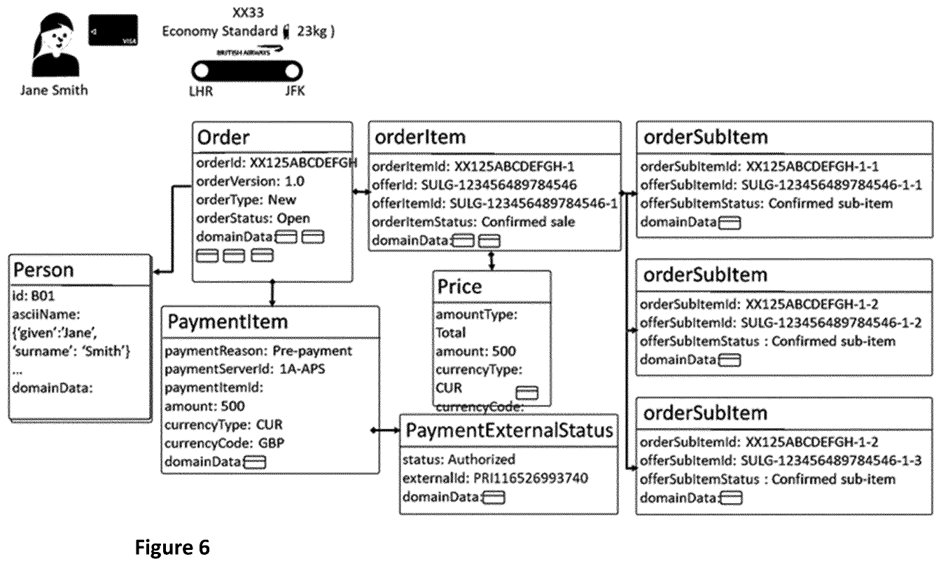

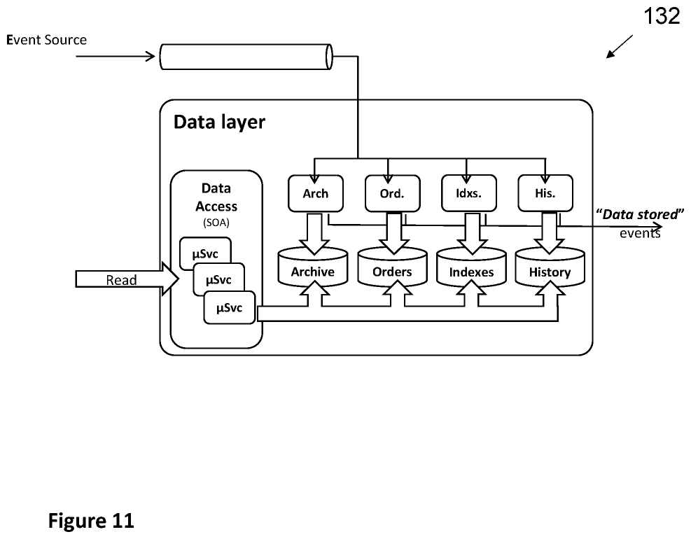

FIG. 11 shows a more detailed example of an order data record 131. As shown the order data record 131 may comprise a range of data, e.g. orderID, orderVersion, order status, and the like. Each order data record 131 may be associated with a contractual terms of service data record 670, which may contain term data records 671 and condition data records. Furthermore, each order data record 131 may be associated with one or more order item data records 231, each comprising a range of data such as the itemID, the offerID of the referenced product/services, the status and the like. Each order item data record 231 may be linked with at least one term and condition data record 671, 672, and further with at least one sub-item data record 331. Each sub-item data record may also be linked with at least one term and condition data record 671, 672. As shown in FIG. 6, each data record comprises some standard placeholder data fields, namely “domain data” and “extensions”. These placeholder data fields may be used by authorised users, such as providers, third-party applications, and the like, to enrich each data record with extra information, without requiring any software development to integrate the new content. Placeholder data fields allow for the data records to be extended with new data and capabilities, which is currently not possible with existing solutions. Each sub-item 331 is linked with at least one fulfilment item data record 241 comprising a range of data for the product and/or service to be fulfilled. Each fulfilment item data record 241 may be linked to at least one fulfilment task record 641 specifying the tasks expected to be executed by the provider for the fulfilment of the corresponding fulfilment item data record 241. The monitoring of the tasks assigned by the fulfilment task record 641 is performed using a fulfilment task external status data record 741, which is configured to obtain information on the status of a task from the provider system. Similarly, the fulfilment status of each fulfilment item 241 may be monitored by an external status data record 541, which is configured to store data on the fulfilment status, which may be determined based on information obtained directly from an assigned provider system. Therefore, a change in the fulfilment item or a fulfilment status error, may cause some or all of the tasks assigned for execution not to be fulfilled by the assigned provider. As a result, the fulfilment status of item 241 may be registered, due to the change or fulfilment error, as unfulfilled. The OMS may validate the fulfilment status of a fulfilment item 441 against the corresponding terms of service to determine if any of the specified conditions have been met. As shown in FIG. 5, each fulfilment data record also comprises placeholder fields similar to those of the order data records.

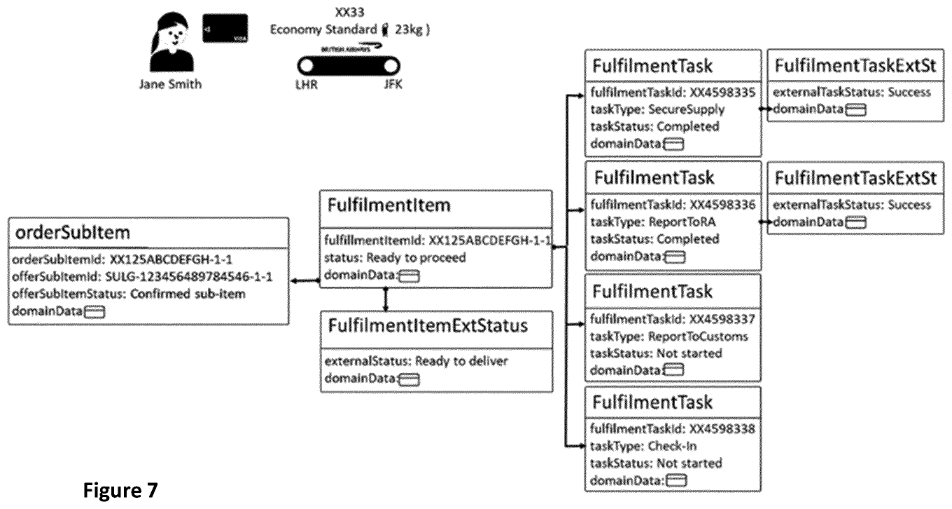

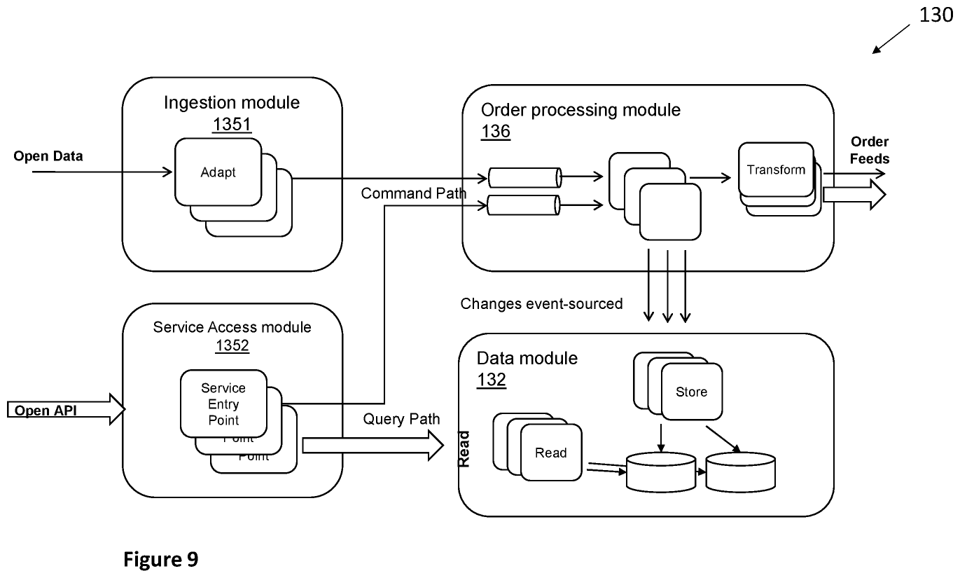

FIGS. 6 and 7 show an example of how an order may be managed in an OMS 130 using the order data model of the present invention. As a shown in FIG. 6, a passenger “Jane Smith” has booked to fly with flight XX33 from LHR to JFK in economy class with airline XX as provider. The order generated may be associated with a personal record containing the personal information of the passenger. Each order is linked to a payment item specifying the payment details of an order and the external status of the payment. The order items may be extracted from each order, once payment has been confirmed, and the sale is final and linked to the corresponding contract sub-items. As shown in FIG. 9, each contract sub-item is linked to at least one fulfilment item associated with an external status data record for monitoring its fulfilment status. Each fulfilment item is processed to extract the corresponding fulfilment tasks to be executed by the provider, which may be linked with tasks status data records storing information on the fulfilment of each task by the provider. At any point, if a change or fulfilment error is registered, the contractual terms of service associated with each sub-item may be triggered, as discussed previously.

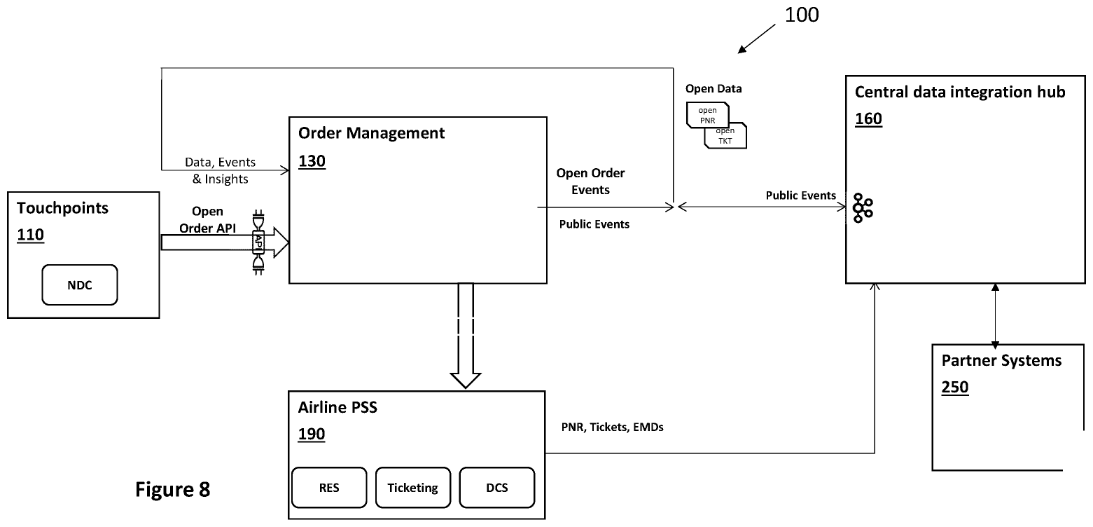

FIG. 8 shows an example of an event-driven streaming architecture for the airline retail platform 100 according to embodiments of the present invention. As shown, the order management system 130 is connected to a plurality of touchpoints 110, which are used by the users to place and manage orders. The orders generated at the touchpoints 110 are pushed in the form of event messages to the order management system 130, where the individual order items and corresponding sub-items contained in the order are extracted, and corresponding order item data record 231 and sub-item data records 331 are generated, each linked to the main order data record 131. For each sub-item data record 331, one or more fulfilment data records are generated, which are transmitted to an assigned provider 190 for fulfilment. The order management system 130 is communicatively coupled with a range of peripheral systems, such as an airline passenger service system (PSS) acting as service provider 190, and a central data integration hub 160. The central data integration hub 160 is configured to receive notifications from the service providers 190 associated with the fulfilment of an order sub-item, and further may be communicatively coupled to partner systems 250 e.g. airport systems, air traffic systems, payment systems, and the like. The central data integration hub 160 is configured to gather the data of interest from different systems and feed the information, in the form of feedback to the order management system 130, where the feedback information is processed to determine the fulfilment status of an order sub-item and/or react to events that may affect the fulfilment of an order sub-item. For example, the airline PSS 190 may be configured for receiving the fulfilment item data records 241 for fulfilment and accordingly generate notifications associated with the fulfilment status of each fulfilment item data record 241, which are communicated to the central data integration hub 160, whereby they are aggregated with additional information collected from partner systems 250. The information collected by the central data integration hub 160 is fed back to the order management system 130 for further processing, which may include checking the fulfilment status, identifying changes/errors, initiating actions, and others.

FIG. 9 shows an exemplified implementation of an order management system 130 shown in FIG. 2 according to embodiments of the present invention. As shown in FIG. 9, the order management system 130, may be provided with an ingestion module 1351 and a service access module 1352, which may be part of the communication module 135. The ingestion module 1351 is configured for receiving the monitoring data communicated from the central data integration hub 160 and/or other connected systems 250. The ingestion module 1351 is configured to process the input data streams to extract events associated with order data records 131, such as a change of an order item, an error in fulfilment status, the generation new order item, and the like. Furthermore, the data ingestion module 1351 is configured to transform, when necessary, the data format of the information received to a data format that can be processed by the order processing module 136. Similarly, the service access module 1352 is configured to provide access to connected service provider systems, via application programming interfaces (API), to the data records stored in the data module 132. Furthermore, the access service module 1352 enables service providers to manage their orders and view their fulfilment status. For example, via the access service module 1352, a service provider may issue a request for a change in an order item and/or an order sub-item. The order processing module 136 is configured to process the input data streams received at the ignition module 1351 and commands issued at the access service module 1352, and accordingly perform the requested actions in the data module 132 e.g. generate new order data records 131 and corresponding fulfilment data records, and/or manage existing order data records 131, and the like. The order processing module 136 is configured to transmit order data to the assigned fulfilment provider 190, and/or other systems. Prior to the transmission, the data format of the order data may be transformed to a destination system data format.

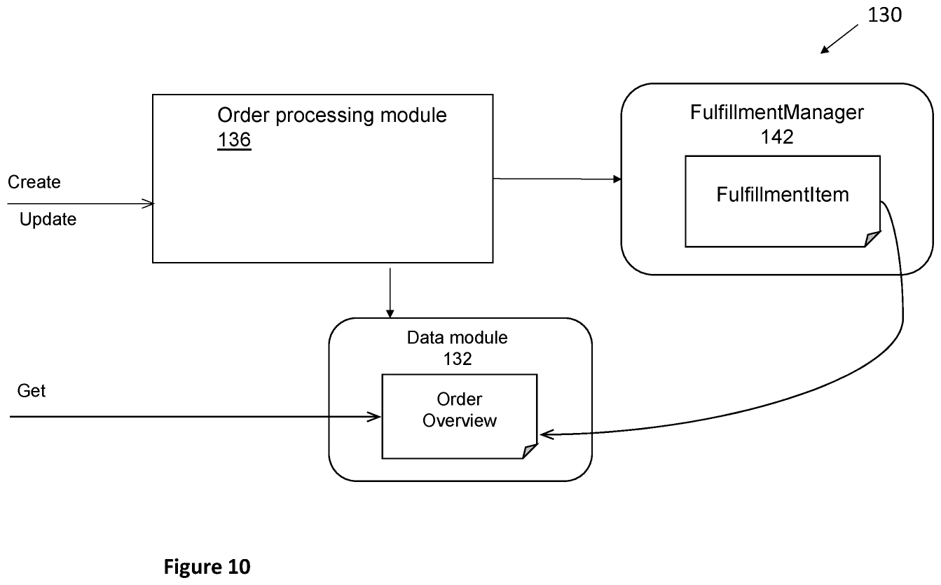

FIG. 10 shows a high-level implementation of an order management system 130 according to embodiments of the present invention. As shown, the order processing module 136 is configured to receive commands for the creation and/or update of order data records. Accordingly, the order processing module 136 may initiate a set of actions that need to be performed to ensure that the creation and/or update of a data record adheres to the contractual terms and conditions. For example, the order processing module 136 may interact with different systems to ensure that the creation and/or update of an order is performed according to the specified contractual conditions. For example, the order processing module 136 may be connected to a payment system to ensure that payment for an order item has been successfully processed before the fulfilment of the order item is actioned. Once the order is processed successfully by the order processing module 136, it is then passed to the fulfilment manager 142, which is configured to manage the fulfilment of the items contained in the order. The fulfilment manager 142 is configured to monitor the fulfilment status of each order item to ensure that the order item is delivered according to the contractual terms agreed. In the case of a fulfilment status change, the fulfilment manager 142 is configured to check whether the status change has caused a violation of the contractual terms, and if does initiate a set of corrective actions. The result of each corrective action in the set is assessed, and if the violation of the contractual conditions persists, the next corrective action is initiated. In essence, the fulfilment manager 142 operates in a control loop to ensure that the contractual terms of each order are satisfied. In the case that a fulfilment issue remains unresolved, an action may be initiated for manual intervention.

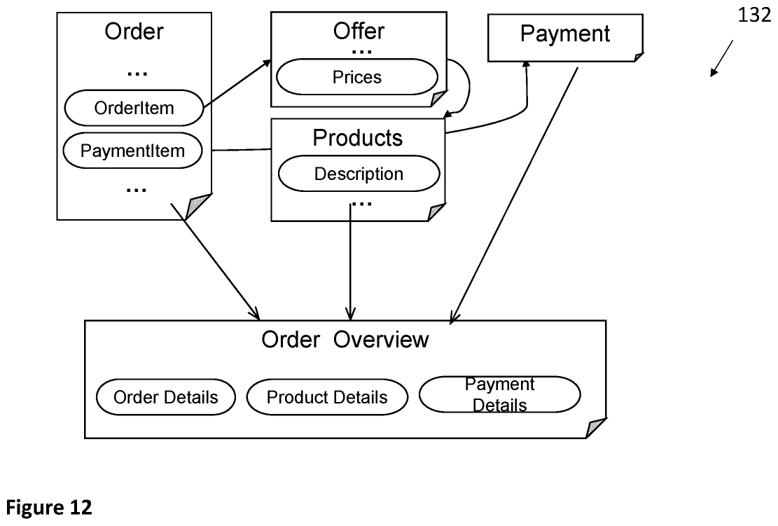

FIG. 11 shows an exemplified implementation of a data module 132 according to embodiments of the present invention As shown the data module 132 may be provided with a data layer, which is configured to structure data according to the order data model of the present invention. The data layer is configured to receive input data from different data sources, which are then stored and processed according to their relevance. For example, the data layer may be configured to structure data into different containers such as archive, orders, indexes, and history. Each container may be provided with an input data processing interface configured for extracting from the input stream data associated with each container. For example, an input stream may contain different data segments each associated with a different container. A data storage event notification may be issued, each time an input data processing interface stores data into a corresponding archive. The data layer further be provided with a data access module configured to enable service providers to access the stored data. For example, each service provided may initiate, via an API, a read request to retrieve data from a data container of the data layer. As such the data layer is configured to aggregate data from different data domains of the airline commercial platform 100 e.g. order domain, payment domain, offer domain, into a consolidated order representation, as shown in FIG. 12. In this way, the data from the different domains is aggregated into a single data representation, where the details of each domain are presented independently.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. The computer-readable program instructions for carrying out operations of the embodiments of the invention may be, for example, assembly language or either source code or object code is written in any combination of one or more programming languages.

The program code embodied in any of the applications/modules described herein is capable of being individually or collectively distributed as a program product in a variety of different forms. In particular, the program code may be distributed using the computer-readable storage medium having the computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of information, such as computer-readable instructions, data structures, program modules, or other data. Computer-readable storage media may further include RAM, ROM, erasable programmable read-only memory (EPROM), electrically erasable programmable read-only memory (EEPROM), flash memory or other robust state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or an external computer or external storage device via a network.

Computer-readable program instructions stored in a computer-readable medium may be used to direct a computer, other types of programmable data processing apparatus, or other devices to function in a particular manner, such that the instructions stored in the computer-readable medium produce an article of manufacture including instructions that implement the functions/acts specified in the flowcharts, sequence diagrams, and/or block diagrams. The computer program instructions may be provided to one or more processors of a general-purpose computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the invention. Moreover, any of the flowcharts, sequence diagrams, and/or block diagrams may include more or fewer blocks than those illustrated consistent with embodiments of the invention.

1. A data model operable in a processor of an order management system for structuring data, the order management system being configured to manage product and/or service orders placed by users via a plurality of digital channels and manage and monitor their fulfilment by assigned providers according to corresponding contractual terms of service agreed between a user and a provider for the provision of the purchased products or services, the data model comprising:
a first data container configured to store a plurality of order data records storing information on product or service orders placed by the users through the digital channels and the corresponding contractual terms of service,
each order data record being assigned an order identifier and comprising at least one order item data record storing information on the type of the purchased product or service and corresponding contractual terms of service,
each order item data record comprising sub-order items specifying the product or services purchased by a user and the corresponding contractual terms of service, each order sub-item being assigned by the processor to a corresponding provider for fulfilment, wherein the terms of service specify actions to be taken when certain conditions are met; and
a fulfilment data container configured to store a plurality of fulfilment item data records, each associated with a corresponding order sub-item data record of an order data record, each fulfilment item data record being configured to store fulfilment status information of a fulfilment item associated with a product or service referenced in the corresponding order sub-item data record.

2. The data model according to claim 1, wherein each fulfilment item data record is configured to store changes and/or fulfilment errors associated with a fulfilment item.

3. The data model according to claim 2, wherein the data model is configured, upon registration of a change and/or a fulfilment status error, to identify and retrieve from the corresponding order sub-item the contractual terms of service to determine the conditions that need to be checked following the change and/or fulfilment error and accordingly initiate the corresponding actions.

4. The data model according to claim 1, wherein each data record in the first data container and fulfilment data container comprise placeholder data fields configured to store extension data for enriching the description of the corresponding data records.

5. The data model according to claim 1, wherein the data model comprises an association data container storing a relationship mapping between the order sub-item data records and fulfilment data records.

6. The data model according to claim 1, wherein the data model comprises a provider data container specifying a. relationship mapping between each fulfilment data record and a fulfilment system of a provider.

7. The data model according to claim 1, wherein the fulfilment data container is configured to obtain fulfilment information of a order sub-item from a fulfilment monitoring system communicatively coupled to the fulfilment system of the assigned provider.

8. The data model according to claim 1, wherein the contractual terms of service in each corresponding data record are in the form of an extensible mark-up language.

9. The data model according to claim 8, wherein every term and/or condition is represented by a key and a value.

10. The data model according to claim 9, wherein the key identities the type of the corresponding term or condition.

11. The data model according to claim 8, wherein the value comprises data that is specific to the given term or condition type.

12. The data model according to claim 1, wherein each order sub-item data record is assigned to a user.

13. An order management system configured to manage product or service orders placed by users via a plurality of digital data channels and monitor their fulfilment by the assigned providers according to corresponding contractual terms of service agreed between a user and a provider for the provision of the purchased products or services, the terms of service specifying actions to be taken when certain conditions are met, the order management system comprising:
a communication module configured to receive order input data from the plurality of digital channels and monitoring data from at least a central data integration hub, wherein each order input data comprises order data associated with products and/or services order placed by a user at a digital channel, and wherein the monitoring data comprises data associated with the fulfilment of an order;
a database management system configured to store data associated with the received product or service orders and their fulfilment;
a processing module configured to process each order input data to extract order data comprising information on the order items, order sub-items, and corresponding contractual terms of service and generate, based on the order data model of claim 1, the corresponding order data record, one or more order item data records associated with each order item in the order, one or more order sub-item data records associated with sub-term specified in the order items of the order, and one or more fulfilment item data records associated with the one or more sub-items data records;
wherein the processor is configured to associate and transmit, based on a first data portion of the order data, each fulfilment item data record to a fulfilment system of a corresponding provider; and
wherein the processor is configured to monitor the fulfilment status of each fulfilment item data record by the assigned provider based on the monitoring data received at the communication module.

14. The order management system of claim 13, wherein the processing module is configured, prior to the transmission of a fulfilment data record, to check the compatibility of the data format of the fulfilment data record with the data format of the fulfilment system of the assigned provider, and wherein upon detecting an incompatibility, the processor is configured for converting the data format of the fulfilment data to a data format that is compatible with the fulfilment system of the assigned provider.

15. The order management system of claim 13, wherein the processing module is configured, upon registering a change in the order data record and/or an error in the status of a fulfilment item data record, to identify and retrieve the corresponding contractual terms of service associated with the corresponding order sub-item data record, to determine whether the detected change and/or error trigger any of the conditions specified in the contractual terms, and wherein if certain conditions are triggered, the processing module is configured to initiate a set of corresponding corrective actions to satisfy the triggered conditions of the contractual terms.

16. The order management system of claim 15, wherein the processing module is configured to sequentially iterate through the set of corresponding corrective actions, until a corrective action is identified that satisfies the contractual terms associated with the affected order sub-item.

17. The order management system of claim 1, wherein the communication module comprises a data ingestion module configured to process the monitoring data received from the central integration hub to determine whether the data format of the monitor data is compatible with the processing format of the order management module, and wherein upon detecting an incompatibility, the data ingestion module is configured to transform format of the monitoring data.

18. The order management system of claim 17, wherein the data ingestion module is configured to process the input data streams in real-time to extract events associated with product or service orders.

19. The order management system of claim 1, wherein the order management system is one or more of: communicatively coupled to a travel offer management system; and based on an event-driven streaming architecture.

20. (canceled)

21. A computer implemented method for processing and structuring data in an order management system, the method comprising the steps of:
receiving input data from a touchpoint, the input data associated with a data object comprising one or more data item objects, and each data item object comprising one or more data sub-item objects;
processing the data object and generating for each data item and associated data sub-item objects a corresponding data record, which is stored in a database of a database management system, each data sub-item object comprises a set of fulfilment conditions that need to be satisfied for the provision of a service by a service provider;
generating for each data sub-item a corresponding data fulfilment object;
communicating the data fulfilment object to the fulfilment system of the assigned service provider; and
monitoring the fulfilment status of the data fulfilment object by the assigned application provider;
wherein the step of monitoring the fulfilment status comprising the steps of:
receiving monitoring data from a central data integration hub associated with the fulfilment status of the data fulfilment object;
determining based on monitoring data and/or input data received from the touchpoints a change and/or an error in the fulfilment status;
and wherein upon detecting a change and/or error, retrieving the corresponding fulfilment condition to determine whether the detected change and/or error triggered any of the fulfilment conditions; and
if the change and/or error caused certain conditions to be triggered, initiating a set of corresponding corrective actions to satisfy the triggered conditions.

22. (canceled)
